(19) United States
(12) Patent Application Publication
(10) Pub. No.: US 2021/0082644 A1
(43) Pub. Date: Mar. 18, 2021

(54) Gas Circuit Breaker

(71) Applicant: Hitachi, Ltd., Tokyo (JP)

(72) Inventors: Hideyuki KOTSUJI, Tokyo (JP); Hajime URAI, Tokyo (JP); Masanao TERADA, Tokyo (JP); Takahiro NISHIMURA, Tokyo (JP); Yuichiro YAMANE, Tokyo (JP)

(21) Appl. No.: 16/943,076

(22) Filed: Jul. 30, 2020

(30) Foreign Application Priority Data
Sep. 13, 2019 (JP) 2019-167169

(51) Int. Cl. H01H 33/91; H01H 33/70; H01H 33/82

(52) U.S. Cl. CPC H01H 33/91; H01H 33/82; H01H 33/7023

(57) ABSTRACT

A movable main contact; a movable arc contact; a puffer cylinder including the movable main contact; a hollow rod that is arranged inside the puffer cylinder, includes the movable arc contact, and has an inner space through which an insulating gas flows; a thermal puffer chamber surrounded by the puffer cylinder and the hollow rod; an insulating cover that is provided to the hollow rod, and covers the movable arc contact; an insulating nozzle provided to the puffer cylinder; and a cylindrical flow guide extending in the axial direction are included. The flow guide is installed in the thermal puffer chamber, positioned on the outer circumference side of the hollow rod, and connected to the insulating nozzle. The space between the flow guide and the hollow rod is connected to the space between the insulating nozzle and the insulating cover, and serves as a flow path of the insulating gas.

### CLAIM OF PRIORITY

The present application claims priority from Japanese Patent Application JP 2019-167169 filed on Sep. 13, 2019, the content of which is hereby incorporated by reference into this application.

### BACKGROUND OF THE INVENTION

### 1. Field of the Invention

The present invention relates to gas circuit breakers, and in particular relates to gas circuit breakers that blow an insulating gas onto an arc generated between contacts at the time of current interruption, and thereby extinguish the arc.

### 2. Description of the Related Art

In recent years, voltages and currents that electrical power systems are required to support are increasing, and the capacities of gas circuit breakers are increasing in order to attain required interruption performance. In addition, for cost reduction, sizes of gas circuit breakers have also been reduced by optimization of structures such as interrupting sections, evacuating sections or shields. However, in terms of size-reduction of apparatuses, there is a limitation for puffer-type gas circuit breakers that use only mechanical compression to attain the pressure of a gas to be blown at the time of arc extinction. Along with the increase in operation energy of operation devices, thermal-puffer-type gas circuit breakers that expand a gas by using arc heat generated at the time of current interruption, and extinguish an arc by blowing the gas by using the pressure resulting from the expansion are under development.

Thermal-puffer-type gas circuit breakers extinguish an arc generated between a fixed arc contact and a movable arc contact by blowing a high-pressure insulating gas compressed in a mechanical puffer chamber and a thermal puffer chamber onto the arc. Since the gas pressure is formed by using arc heat in the thermal puffer chamber in thermal-puffer-type gas circuit breakers, the operation force required for an operation device can be reduced, and the size-reduction of the operation device is possible.

An example of conventional thermal-puffer-type gas circuit breakers is described in JP-2012-079601-A. In the gas circuit breaker described in JP-2012-079601-A, a thermal puffer chamber is provided in series to a mechanical puffer chamber, a partitioning member that divides the inner space of the thermal puffer chamber in the radial direction is provided in the thermal puffer chamber, a switch valve is provided as gas flow control means between an arc space and the thermal puffer chamber, and a movable valve is provided between the thermal puffer chamber and the mechanical puffer chamber. At the time of interruption of a large current, the switch valve causes a high-temperature, high-pressure arc-extinguishing gas from the arc space to pass through the space on the outer circumference side of the partitioning member and then through the space on the inner circumference side of the partitioning member, and to be blown onto an arc. At the time of interruption of an intermediate to small current, an arc-extinguishing gas from the mechanical puffer chamber is guided only to the space on the inner circumference side of the partitioning member and blown onto an arc.

Since a gas pressure is formed by using arc heat in a thermal puffer chamber in a thermal-puffer-type gas circuit breaker, a gas to be blown onto an arc generated at the time of current interruption becomes a hot gas at a high temperature, and there is a fear that the insulating performance of the gas deteriorates, and the interruption performance deteriorates. In particular, if a current to be interrupted is large, the arc heat increases. Accordingly, the gas temperature becomes higher, and sufficient interruption performance might not be attained.

The gas circuit breaker described in JP-2012-079601-A has improved arc extinction performance at the time of interruption of large currents and at the time of interruption of intermediate to small currents by including the partitioning member that divides the inner space of the thermal puffer chamber in the radial direction, the switch valve and the movable valve. However, since the partitioning member is provided in the thermal puffer chamber in the gas circuit breaker described in JP-2012-079601-A, the volume of the thermal puffer chamber, that is, the volume of the gas used for arc extinction, decreases, and there is a fear that the interruption performance deteriorates. In particular, since the gas is blown onto an arc only from the space on the inner circumference side of the partitioning member at the time of interruption of an intermediate to small current, the volume of the gas used for arc extinction might be halved. In addition, since the gas circuit breaker described in JP-2012-079601-A includes the partitioning member, the switch valve and the movable valve, there is a fear that the number of parts increases, and the cost increases.

In this manner, conventional gas circuit breakers have a problem that if a gas pressure is formed by using arc heat in a thermal puffer chamber, the temperature of a gas to be blown onto an arc rises to cause deterioration of the insulating performance of the gas or cause reduction of the gas volume, and there is a fear that the interruption performance deteriorates. In addition, they have a problem that there is a fear that if additional operation parts such as a switch valve or a movable valve are provided, the cost increases.

An object of the present invention is to provide a gas circuit breaker in which a high-temperature gas having flowed into a thermal puffer chamber is cooled, and blown onto an arc, thereby preventing deterioration of the insulating performance of the gas, and improving the interruption performance of the gas circuit breaker.

### SUMMARY OF THE INVENTION

A gas circuit breaker of the present invention includes; a cylindrical gas tank that is filled with an insulating; a movable main contact that moves in an axial direction to separate from a fixed main contact and interrupt a current; a movable arc contact that generates an arc between the movable arc contact and a fixed arc contact at a time of the interruption of the current; a puffer cylinder having one end portion at which the movable main contact is provided; a hollow rod that is arranged inside the puffer cylinder, has one end portion at which the movable arc contact is provided, and has an inner space through which the insulating gas flows; a thermal puffer chamber that is formed by being surrounded by the puffer cylinder and the hollow rod; an insulating cover that is provided at one end portion of the hollow rod, and covers the movable arc contact; an insulating nozzle provided at one end portion of the puffer cylinder; and a flow guide that is a cylindrical member extending in the axial direction, the movable main contact, the movable arc contact, the puffer cylinder, the hollow rod, the thermal puffer chamber, the insulating cover, the insulating nozzle, and the flow guide being included in the cylindrical gas tank. The flow guide is installed in the thermal puffer chamber, is positioned on the outer circumference side of the hollow rod, and has one end portion connected to the insulating nozzle. The space between the flow guide and the hollow rod is connected to the space between the insulating nozzle and the insulating cover, and serves as a flow path of the insulating gas.

According to the present invention, in a gas circuit breaker that can be provided, a high-temperature gas having flowed into a thermal puffer chamber is cooled, and blown onto an arc. Thereby, deterioration of the insulating performance of the gas is prevented, and the interruption performance of the gas circuit breaker is improved.

### BRIEF DESCRIPTION OF THE DRAWINGS

FIG. 1 is a cross-sectional view illustrating the schematic configuration of a conventional gas circuit breaker in a closing state;

FIG. 2 is a cross-sectional view illustrating the schematic configuration of the conventional gas circuit breaker at the time of interruption;

FIG. 3 is a cross-sectional view illustrating the schematic configuration of a gas circuit breaker according to a first embodiment of the present invention at the time of interruption;

FIG. 4 is a figure illustrating a gas flow having flowed from an arc space into a thermal puffer chamber at the time of interrupting an intermediate to small current;

FIG. 5 is a cross-sectional view illustrating the schematic configuration of a gas circuit breaker according to a second embodiment of the present invention at the time of interruption;

FIG. 6 is a cross-sectional view of a flow guide as seen along a cutting plane line A-A in FIG. 5;

FIG. 7 is a figure illustrating the flow guide including a tapered hole;

FIG. 8 is a cross-sectional view illustrating the schematic configuration of a gas circuit breaker according to a third embodiment of the present invention at the time of interruption;

FIG. 9 is a cross-sectional view illustrating the schematic configuration of another gas circuit breaker according to the third embodiment of the present invention at the time of interruption; and

FIG. 10 is a cross-sectional view illustrating the schematic configuration of a gas circuit breaker according to a fourth embodiment of the present invention at the time of interruption.

### DESCRIPTION OF THE PREFERRED EMBODIMENTS

In the following, gas circuit breakers according to embodiments of the present invention are explained by using the drawings. In the drawings used in the present specification, identical or corresponding constituent elements are given identical signs, and repetitive explanations about these constituent elements are omitted in some cases. Note that the embodiments illustrated below are merely examples of embodiments of the present invention, and the content of the present invention is not limited to the following aspects.

### First Embodiment

First, a conventional thermal-puffer-type gas circuit breaker is explained.

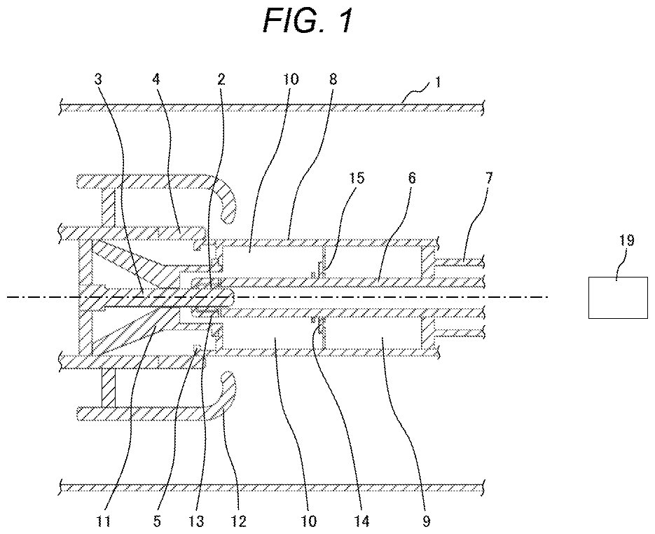

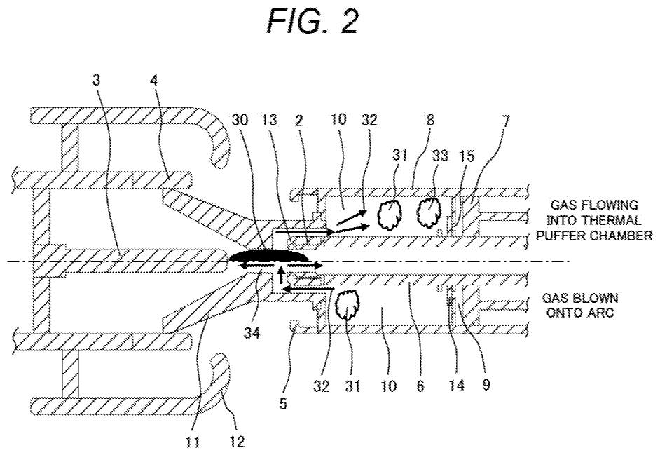

FIG. 1 is a cross-sectional view illustrating the schematic configuration of a conventional gas circuit breaker in a closing state (energized state). FIG. 2 is a cross-sectional view illustrating the schematic configuration of the conventional gas circuit breaker at the time of interruption. In FIG. 2, the upper half illustrates a gas flow 32 that is generated when a gas flows from an arc space 34 (a space where an arc 30 is generated) into a thermal puffer chamber 10, and the lower half illustrates the gas flow 32 that is generated when the gas is blown onto the arc 30 from the thermal puffer chamber 10. Note that an illustration of a gas tank 1 is omitted in FIG. 2.

The gas circuit breaker includes the cylindrical gas tank 1 filled with an insulating gas, a movable arc contact 2, a fixed arc contact 3, a movable main contact 5 and a fixed main contact 4. The movable arc contact 2, the fixed arc contact 3, the movable main contact 5 and the fixed main contact 4 are housed inside the gas tank 1. SF₆ can be used as an insulating gas, for example. Note that insulating gases that can be used are not limited to SF₆, but other insulating gases such as dry air or a nitrogen gas may be used.

In the following, the direction of the axis of the gas tank (the horizontal direction in FIG. 1) is called the “axial direction,” the direction perpendicular to the axial direction is called the “radial direction,” and the direction surrounding the axial direction is called the “circumferential direction.” The direction in which the movable arc contact 2 and the movable main contact 5 move when the gas circuit breaker performs opening operation to switch its operation state from the closing state to the opening state (the rightward direction in FIG. 1) is called the “interrupting direction.” The direction in which the movable arc contact 2 and the movable main contact 5 move when the gas circuit breaker performs closing operation to switch its operation state from the opening state to the closing state (the leftward direction in FIG. 1) is called the “non-interrupting direction.” In addition, the insulating gas is also called the “gas” simply.

The movable arc contact 2 faces the fixed arc contact 3 in the axial direction, can move in the axial direction, and generates an arc between the movable arc contact 2 and the fixed arc contact 3 at the time of interruption of current. The movable arc contact 2 is positioned in the interrupting direction relative to the fixed arc contact 3 (the right side of FIG. 1), is electrically connected with the fixed arc contact 3 in the closing state, and is physically separated from the fixed arc contact 3 in the opening state.

The movable main contact 5 faces the fixed main contact 4 in the axial direction, can move in the axial direction, and performs opening operation of interrupting current and closing operation of not interrupting current. The movable main contact 5 is positioned in the interrupting direction relative to the fixed main contact 4 (the right side of FIG. 1), is electrically connected with the fixed main contact 4 in the closing state, and is physically separated from the fixed main contact 4 in the opening state. The movable main contact 5 and the fixed main contact 4 form a main contact point.

The gas circuit breaker further includes a puffer cylinder 8, a hollow rod 6, a puffer piston 7, a mechanical puffer chamber 9, the thermal puffer chamber 10, an insulating cover 13, an insulating nozzle 11, a shield 12 and an operation device 19.

The puffer cylinder 8 is positioned on the outer circumference side (radially outer side) of the movable arc contact 2, and is arranged so as to share a common central axis with the movable arc contact 2. The puffer cylinder 8 has one end portion in the non-interrupting direction at which the movable main contact 5 is provided, and the puffer cylinder 8 houses the hollow rod 6. Note that the inner circumferential surface of the puffer cylinder 8 is parallel with the axial direction.

The hollow rod 6 is arranged inside the puffer cylinder 8 so as to share a common central axis with the puffer cylinder 8. The hollow rod 6 has one end portion in the non-interrupting direction at which the movable arc contact 2 is provided. The hollow rod 6 has a hollow inner space through which the insulating gas flows. Note that the outer circumferential surface of the hollow rod 6 is parallel with the axial direction.

The puffer piston 7 is supported by a mounting eye provided on the inner circumferential surface of the gas tank 1, positioned inside the puffer cylinder 8, and moves in a space formed between the puffer cylinder 8 and the hollow rod 6.

The mechanical puffer chamber 9 is formed by being surrounded by the puffer cylinder 8, the hollow rod 6 and the puffer piston 7.

The thermal puffer chamber 10 is formed by being surrounded by the puffer cylinder 8 and the hollow rod 6, the insulating gas flows into or flows out of the thermal puffer chamber 10, and the thermal puffer chamber 10 has a constant volume. The thermal puffer chamber 10 includes a check valve 14, is adjacent to the mechanical puffer chamber 9 in the axial direction, and is connected to the mechanical puffer chamber 9 by a communicating hole 15. The communicating hole 15 is provided through a partition wall between the thermal puffer chamber 10 and the mechanical puffer chamber 9, and is opened and closed by the check valve 14. That is, communication between the thermal puffer chamber 10 and the mechanical puffer chamber 9 is controlled by the check valve 14.

Inside the thermal puffer chamber 10, the check valve 14 is provided on the outer circumferential surface of the hollow rod 6, and is moved in the axial direction by a pressure difference between the thermal puffer chamber 10 and the mechanical puffer chamber 9. When the pressure inside the thermal puffer chamber 10 is lower than the pressure inside the mechanical puffer chamber 9, the check valve 14 moves in the non-interrupting direction, and opens the communicating hole 15 to establish communication between the thermal puffer chamber 10 and the mechanical puffer chamber 9. When the pressure inside the thermal puffer chamber 10 is higher than the pressure inside the mechanical puffer chamber 9, the check valve 14 moves in the interrupting direction, and closes the communicating hole 15 to interrupt communication between the thermal puffer chamber 10 and the mechanical puffer chamber 9.

The insulating cover 13 is provided at one end portion of the hollow rod 6 in the non-interrupting direction, and covers the movable arc contact 2.

The insulating nozzle 11 is positioned on the outer circumference side of the insulating cover 13, and provided at one end portion of the puffer cylinder 8 in the non-interrupting direction. The space between the insulating nozzle 11 and the insulating cover 13 communicates with the thermal puffer chamber 10, and serves as a gas flow path.

The shield 12 covers the fixed arc contact 3 and the fixed main contact 4.

The operation device 19 can move the insulating nozzle 11, the puffer cylinder 8, the hollow rod 6, the movable arc contact 2, the movable main contact 5 and the like in the interrupting direction.

In the closing state of the gas circuit breaker (FIG. 1), the movable arc contact 2 is in contact with the fixed arc contact 3, and the movable main contact 5 is in contact with the fixed main contact 4.

At the time of a short-circuit failure or the like of an electrical power system, the gas circuit breaker receives an instruction for opening, and performs interrupting operation. The operation device 19 moves the hollow rod 6 and the puffer cylinder 8 in the interrupting direction, and moves the movable arc contact 2 and the movable main contact 5 in the interrupting direction to thereby perform the interrupting operation. The movable arc contact 2 is physically opened by being separated from the fixed arc contact 3, and the movable main contact 5 is physically opened by being separated from the fixed main contact 4 (FIG. 2). Even after the movable main contact 5 is opened by being separated from the fixed main contact 4, a current flows between the movable arc contact 2 and the fixed arc contact 3, and the arc 30 is generated (FIG. 2). The gas circuit breaker blows a high-pressure insulating gas onto the generated arc 30 to extinguish the arc 30.

When the movable arc contact 2 and the movable main contact 5 move at the time of interruption, the puffer cylinder 8 moves relative to the puffer piston 7. Thereby, the puffer piston 7 compresses the insulating gas inside the mechanical puffer chamber 9. More specifically, a driving force of the operation device 19 is transmitted to the puffer cylinder 8 via an insulating rod (not illustrated) connected to the operation device, and the hollow rod 6, and the puffer cylinder 8 moves. Thereby, the insulating gas inside the mechanical puffer chamber 9 is compressed by the puffer piston 7. If the check valve 14 is opening the communicating hole 15, the compressed insulating gas passes through the communicating hole 15 to flow from the mechanical puffer chamber 9 into the thermal puffer chamber 10, flows through the space between the insulating nozzle 11 and the insulating cover 13 to be blown onto the arc 30, and extinguishes the arc 30 (the figure on the lower half of FIG. 2).

In the thermal-puffer-type gas circuit breaker, a hot gas 31 which is a gas at a temperature raised by arc heat is taken into the thermal puffer chamber 10 to thereby form a pressure. Because of this, the thermal-puffer-type gas circuit breaker operates according to different principles of interruption depending on the magnitudes of current to be interrupted.

At the time of interruption of a large current when a current to be interrupted is relatively large (e.g. a current at the time near a peak), the energy of the arc 30 is high, the gas pressure in the arc space 34 (the space where the arc 30 is generated) is higher than the gas pressure in the thermal puffer chamber 10, and the hot gas 31 passes through the space between the insulating nozzle 11 and the insulating cover 13 to flow into the thermal puffer chamber 10 (the figure on the upper half of FIG. 2). The pressure inside the thermal puffer chamber 10 rises significantly due to the arc heat, and is higher than the pressure inside the mechanical puffer chamber 9. Because of this, the check valve 14 closes the communicating hole 15 to interrupt communication between the thermal puffer chamber 10 and the mechanical puffer chamber 9. The insulating gas compressed by the pressure inside the thermal puffer chamber 10 is blown onto the arc 30 from the thermal puffer chamber 10, and the arc 30 is extinguished.

At the time of interruption of an intermediate to small current when a current to be interrupted is relatively small, the pressure inside the thermal puffer chamber 10 is lower than the pressure inside the mechanical puffer chamber 9 even if the pressure inside the thermal puffer chamber 10 rises due to the arc heat. Because of this, the check valve 14 opens the communicating hole 15 to establish communication between the thermal puffer chamber 10 and the mechanical puffer chamber 9. The insulating gas compressed by the mechanical puffer chamber 9 passes through the communicating hole 15 from the mechanical puffer chamber 9 to flow into the thermal puffer chamber 10, and is blown onto the arc 30 from the thermal puffer chamber 10, and the arc 30 is extinguished.

When the gas flows into the thermal puffer chamber 10 (the figure on the upper half of FIG. 2), the hot gas 31 passes through the space between the insulating nozzle 11 and the insulating cover 13 from the arc space 34 to flow into the thermal puffer chamber 10. The hot gas 31 having flowed into the thermal puffer chamber 10 advances deep (the right side of FIG. 2) into the thermal puffer chamber 10 in the interrupting direction. However, there is a cool gas 33 (a gas at a temperature lower than the temperature of the hot gas 31) in the thermal puffer chamber 10, and the cool gas 33 is pushed by the hot gas 31 deep into the thermal puffer chamber 10 in the interrupting direction. Because of this, the hot gas 31 does not spread over the entire thermal puffer chamber 10, is not sufficiently mixed with the cool gas 33, and does not exchange heat with the cool gas 33 efficiently.

In particular, at the time of interruption of an intermediate to small current when a current to be interrupted is relatively small, the energy of the arc 30 is low. Accordingly, the gas flow rate is not high, and the hot gas 31 does not reach deep (the right side of FIG. 2) into the thermal puffer chamber 10 in the interrupting direction, but remains still near a portion of the thermal puffer chamber 10 at which the thermal puffer chamber 10 communicates with the arc space 34 (the entrance of the thermal puffer chamber 10). Because of this, a sufficient effect of cooling the hot gas 31 resulting from mixing with the cool gas 33 inside the thermal puffer chamber 10 is not attained, and the temperature of the hot gas remains high.

When the energy of the arc 30 becomes low, the pressure in the arc space 34 lowers, and the pressure in the thermal puffer chamber 10 becomes higher than the pressure in the arc space 34, the insulating gas starts being blown onto the arc 30 from the thermal puffer chamber 10. When the insulating gas is blown onto the arc 30 (the figure on the lower half of FIG. 2), the hot gas 31 is blown onto the arc 30 starting from an insufficiently cooled portion of the hot gas 31 that is near the portion of the thermal puffer chamber 10 at which the thermal puffer chamber 10 communicates with the arc space 34. Because of this, there is a fear that the insulating performance of the gas used for arc extinction deteriorates, and sufficient interruption performance cannot be attained.

A gas circuit breaker according to a first embodiment of the present invention is explained. In the following, explanations of configurations of the gas circuit breaker according to the present embodiment that are common to the conventional gas circuit breaker illustrated in FIG. 1 and the FIG. 2 are omitted, and configurations that are different from those of the conventional gas circuit breaker are mainly explained.

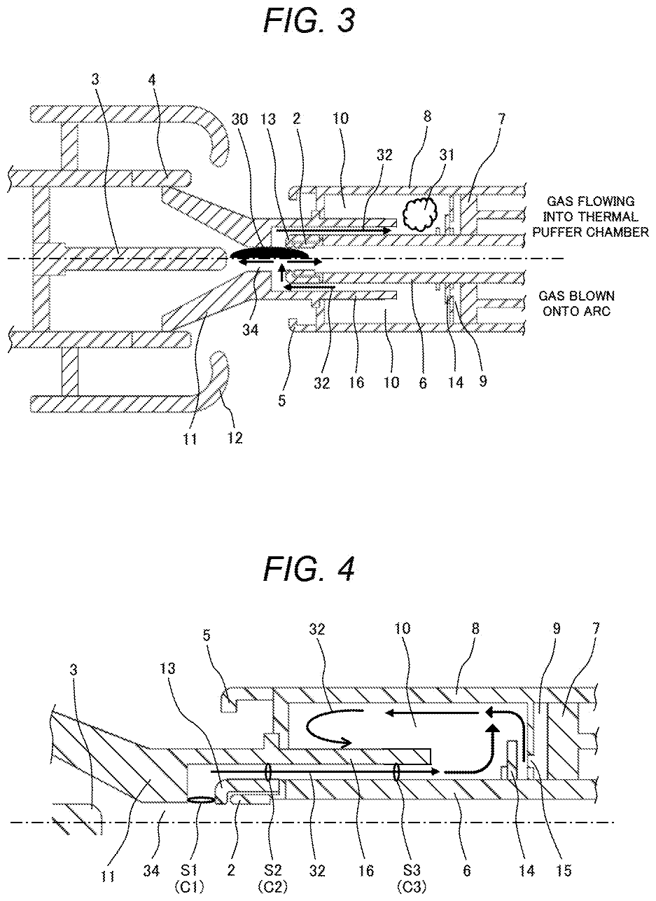

FIG. 3 is a cross-sectional view illustrating the schematic configuration of the gas circuit breaker according to the present embodiment at the time of interruption. Similar to FIG. 2, in FIG. 3, the upper half illustrates the gas flow 32 that is generated when the gas flows from the arc space 34 (the space where the arc 30 is generated) into the thermal puffer chamber 10, the lower half illustrates the gas flow 32 that is generated when the gas is blown onto the arc 30 from the thermal puffer chamber 10, and an illustration of the gas tank 1 is omitted.

The gas circuit breaker according to the present embodiment includes a flow guide 16, which is a cylindrical member extending in the axial direction. The flow guide 16 is installed in the thermal puffer chamber 10, positioned on the outer circumference side (radially outer side) of the hollow rod 6, and has one end portion connected to the insulating nozzle 11. The flow guide 16 is a member provided in the thermal puffer chamber 10 such that the insulating nozzle 11 extends in the axial direction. The space between the flow guide 16 and the hollow rod 6 is connected to the space between the insulating nozzle 11 and the insulating cover 13, and serves as a gas flow path that establishes communication between the thermal puffer chamber 10 and the arc space 34.

The flow guide 16 forms, with the hollow rod 6, a flow path that guides the hot gas 31 deep (the right side of FIG. 3) into the thermal puffer chamber 10 in the interrupting direction when the gas flows from the arc space 34 to the thermal puffer chamber 10 (the figure on the upper half of FIG. 3). In the present embodiment, the flow guide 16 extends in parallel with the axial direction, that is, in parallel with the inner circumferential surface of the puffer cylinder 8, and causes the hot gas 31 to flow in parallel with the axial direction when the hot gas 31 flows into the thermal puffer chamber 10.

The flow guide 16 can be formed with a material which is the same as the material of the insulating nozzle 11. The insulating nozzle 11 can be formed with a composite material containing a resin which is less heat-resistant than fluororesin, and an inorganic filler added to the resin. For example, the insulating nozzle 11 can be formed with a fluororesin mixed with boron-nitride (BN) powders or the like. The flow guide 16 may be fabricated integrally with the insulating nozzle 11 or maybe fabricated separately from the insulating nozzle 11, and installed onto the insulating nozzle 11.

Since the gas circuit breaker according to the present embodiment includes the flow guide 16, the hot gas 31 can be guided deep (the right side of FIG. 3) into the thermal puffer chamber 10 in the interrupting direction when the gas flows into the thermal puffer chamber 10 (the figure on the upper half of FIG. 3). By guiding the hot gas 31 deep into the thermal puffer chamber 10 in the interrupting direction, the flow guide 16 sufficiently mixes and cools the hot gas 31 with the cool gas 33 inside the thermal puffer chamber 10, and prevents deterioration of the insulating performance of the gas. In particular, at the time of interruption of an intermediate to small current when the gas flow rate is not high, the flow path formed with the flow guide 16 can prevent the hot gas 31 from remaining still near the portion of the thermal puffer chamber 10 at which the thermal puffer chamber 10 communicates with the arc space 34, and cause the hot gas 31 to reach deep into the thermal puffer chamber 10 in the interrupting direction.

Preferably, the other end portion of the flow guide 16 (the end portion opposite, in the axial direction, to the end portion at which the flow guide 16 is connected to the insulating nozzle 11) is positioned farther from the insulating nozzle 11 in the axial direction than the center of the thermal puffer chamber 10 in the axial direction is. That is, preferably, the other end portion of the flow guide 16 is deeper in the thermal puffer chamber 10 in the interrupting direction (the right side of FIG. 3) than the center of the thermal puffer chamber 10 in the axial direction is. With such a configuration, when the hot gas 31 flows into the thermal puffer chamber 10, the hot gas 31 can be guided more effectively deep into the thermal puffer chamber 10 in the interrupting direction.

FIG. 4 is a figure illustrating part of the figure on the upper half of FIG. 3, and illustrating the gas flow 32 having flowed from the arc space 34 into the thermal puffer chamber 10 at the time of interrupting an intermediate to small current.

Since at the time of interruption of an intermediate to small current, the pressure inside the thermal puffer chamber 10 is lower than the pressure inside the mechanical puffer chamber 9, the check valve 14 opens the communicating hole 15 to establish communication between the thermal puffer chamber 10 and the mechanical puffer chamber 9. The insulating gas compressed in the mechanical puffer chamber 9 passes through the communicating hole 15, flows from the mechanical puffer chamber 9 into the thermal puffer chamber 10, and, inside the thermal puffer chamber 10, forms the gas flow 32 in the space between the flow guide 16 and the puffer cylinder 8. Due to this gas flow 32, the hot gas 31 having flowed along the flow path between the flow guide 16 and the hollow rod 6 can be cooled over the entire internal space of the thermal puffer chamber 10.

Since the gas circuit breaker according to the present embodiment includes the flow guide 16, the hot gas 31 having flowed into the thermal puffer chamber 10 can be sufficiently mixed and cooled with the cool gas 33 inside the thermal puffer chamber 10, and the cooled gas can be blown onto the arc 30. Accordingly, deterioration of the insulating performance of the gas can be prevented, and the interruption performance can be improved.

In addition, preferably, the area of the gas flow path from the thermal puffer chamber 10 into the arc space 34 (the cross-sectional area of the flow path perpendicular to the direction of the gas flow) decreases from the upstream side to the downstream side in the direction of the flow of the gas from the thermal puffer chamber 10 to the arc space 34 (the direction of the gas flow formed when the gas is blown onto the arc 30).

As illustrated in FIG. 4, the flow path area of a flow path C1 that is formed by the insulating nozzle 11 and the insulating cover 13, and opens toward the arc space 34 is defined as S1, the flow path area of a flow path C2 that is formed by the insulating nozzle 11 and the insulating cover 13, and is positioned upstream of the flow path C1 is defined as S2, and the flow path area of a flow path C3 that is formed by the flow guide 16 and the hollow rod 6, is positioned upstream of the flow path C2 and opens toward the thermal puffer chamber 10 is defined as S3.

If the flow path area S3 is larger than the flow path area S2, and the flow path area S2 is larger than the flow path area S1, the flow path area decreases gradually as the gas flows when the gas is blown onto the arc 30. Accordingly, lowering of the gas flow rate due to expansion of the gas does not occur. Because of this, it is possible to prevent the gas flow from becoming still, and blow the gas onto the arc 30 from the thermal puffer chamber 10, to thereby improve the interruption performance of the gas circuit breaker.

### Second Embodiment

A gas circuit breaker according to a second embodiment of the present invention is explained. In the following, configurations of the gas circuit breaker according to the present embodiment that are different from the gas circuit breaker according to the first embodiment are explained mainly.

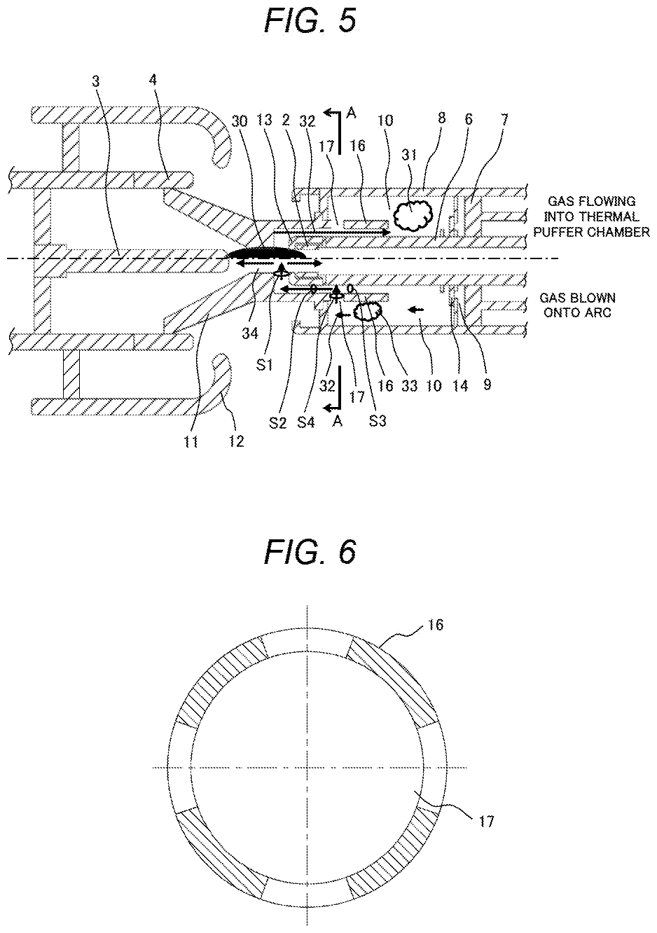

FIG. 5 is a cross-sectional view illustrating the schematic configuration of the gas circuit breaker according to the present embodiment at the time of interruption. Similar to FIG. 3, in FIG. 5, the upper half illustrates the gas flow 32 that is generated when the gas flows from the arc space 34 (the space where the arc 30 is generated) into the thermal puffer chamber 10, the lower half illustrates the gas flow 32 that is generated when the gas is blown onto the arc 30 from the thermal puffer chamber 10, and an illustration of the gas tank 1 is omitted.

In the gas circuit breaker according to the present embodiment, the flow guide 16 includes holes 17 penetrating therethrough in the radial direction. The holes 17 are provided through the side surface of the flow guide 16, and establish communication between the space inside the flow guide 16 and the space outside the flow guide 16. The flow guide 16 may include a single hole 17 in the circumferential direction, but preferably includes a plurality of holes 17 in the circumferential direction. In addition, the flow guide 16 may include a plurality of holes 17 in the axial direction. The number of the holes 17 may be optional.

FIG. 6 is a cross-sectional view of the flow guide 16 as seen along a cutting plane line A-A in FIG. 5. The flow guide 16 illustrated in FIG. 5 and FIG. 6 include four holes 17 in the circumferential direction.

As illustrated in the figure on the upper half of FIG. 5, when the gas flows from the arc space 34 into the thermal puffer chamber 10, the gas flows along the flow path between the insulating nozzle 11 and the insulating cover 13, and the flow path between the flow guide 16 and the hollow rod 6, and the velocity vector in the axial direction increases. Accordingly, the hot gas 31 does not pass through the holes 17, but reaches deep (the right side of FIG. 5) into the thermal puffer chamber 10 in the interrupting direction.

The gas flow 32 at the time when the gas is blown onto the arc 30 from the thermal puffer chamber 10, that is, at the time of interruption, is explained by using the figure on the lower half of FIG. 5.

At the time of interruption of an intermediate to small current, the gas having flowed from the mechanical puffer chamber 9 into the thermal puffer chamber 10 passes through the holes 17, flows along the flow path between the flow guide 16 and the hollow rod 6, and the flow path between the insulating nozzle 11 and the insulating cover 13, and is blown onto the arc 30. The hot gas 31 having reached the thermal puffer chamber 10 passes through the holes 17 and circulates through the inner space of the thermal puffer chamber 10 due to the gas flow from the mechanical puffer chamber 9, and is cooled more effectively.

At the time of interruption of a large current, the check valve 14 is closed, and there are no gas flows from the mechanical puffer chamber 9 into the thermal puffer chamber 10, but the cool gas 33 inside the thermal puffer chamber 10 is guided to the space between the flow guide 16 and the puffer cylinder 8, passes through the holes 17, and is blown onto the arc 30.

In the manner mentioned above, the gas circuit breaker according to the present embodiment can prevent deterioration of the insulating performance of the gas, and can improve the interruption performance.

As illustrated in the figure on the lower half of FIG. 5, the gas flow path area of a hole 17 of the flow guide 16 is defined as S4. Preferably, the flow path area S4 is larger than the flow path area S3 explained in the first embodiment. The flow path area S4 larger than the flow path area S3 can increase the flow amount of the cool gas 33 that passes through the holes 17, and is blown onto the arc 30, and can improve the interruption performance of the gas circuit breaker. Accordingly, the flow path area S4 larger than the flow path area S3, the flow path area S3 larger than the flow path area S2, and the flow path area S2 larger than the flow path area S1 can improve the interruption performance of the gas circuit breaker more effectively.

Preferably, the holes 17 of the flow guide 16 have shapes with the flow path area S4 that decreases from the radially outer side toward the radially inner side.

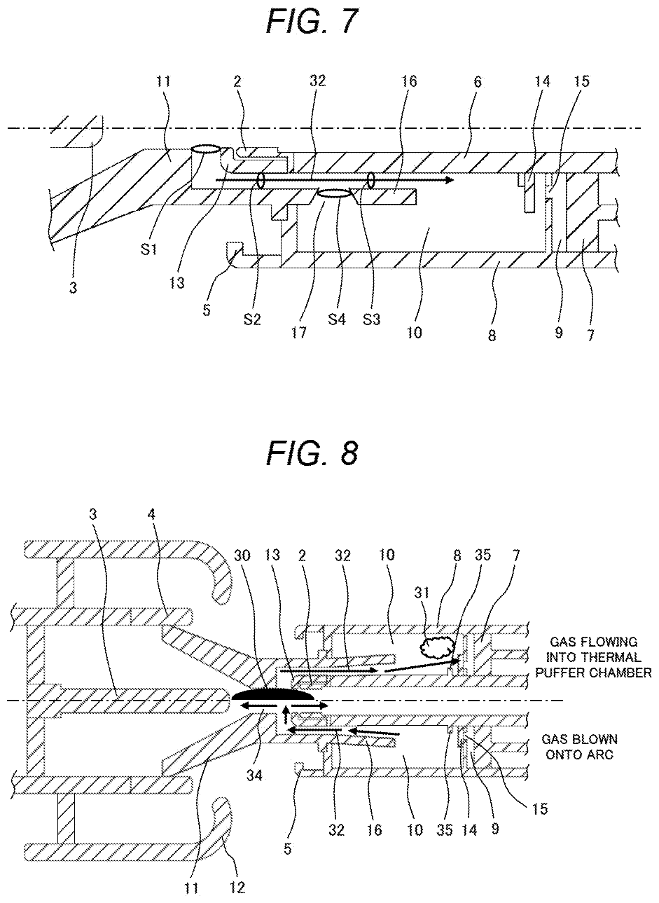

FIG. 7 is a figure corresponding to part of the figure on the lower half of the FIG. 5, and illustrating the flow guide 16 provided with a tapered hole 17. As illustrated in FIG. 7, the flow guide 16 includes the hole 17 having the flow path area S4 that decreases from the radially outer side toward the radially inner side. FIG. 7 illustrates the tapered hole 17, as an example. If the holes 17 of the flow guide 16 have such a shape, it is possible to prevent the gas flow into the holes 17 from becoming still, and blow the gas onto the arc 30 from the thermal puffer chamber 10, to thereby improve the interruption performance of the gas circuit breaker.

### Third Embodiment

A gas circuit breaker according to a third embodiment of the present invention is explained. In the following, configurations of the gas circuit breaker according to the present embodiment that are different from the gas circuit breaker according to the first embodiment are explained mainly.

FIG. 8 is a cross-sectional view illustrating the schematic configuration of the gas circuit breaker according to the present embodiment at the time of interruption. Similar to FIG. 3, in FIG. 8, the upper half illustrates the gas flow 32 that is generated when the gas flows from the arc space 34 (the space where the arc 30 is generated) into the thermal puffer chamber 10, the lower half illustrates the gas flow 32 that is generated when the gas is blown onto the arc 30 from the thermal puffer chamber 10, and an illustration of the gas tank 1 is omitted.

In the first and second embodiments, the flow guide 16 extends in parallel with the axial direction (i.e. in parallel with the inner circumferential surface of the puffer cylinder 8), and causes the hot gas 31 to flow in parallel with the axial direction, and guides the hot gas 31 deep (the right sides of FIGS. 3 and 5) into the thermal puffer chamber 10 in the interrupting direction when the hot gas 31 flows from the arc space 34 into the thermal puffer chamber 10 (the figures on the upper halves of FIGS. 3 and 5).

In the present embodiment, the flow guide 16 extends in the axial direction obliquely toward the radially outer side, and when the hot gas 31 flows into the thermal puffer chamber 10 (the figure on the upper half of FIG. 8), the hot gas 31 is caused to flow toward the radially outer side obliquely to the axial direction. That is, the gas flow path formed with the flow guide 16 and the hollow rod 6 is formed such that the hot gas 31 flowing into the thermal puffer chamber 10 flows toward the check valve 14. The hot gas 31 flowing into the thermal puffer chamber 10 is caused to flow toward the check valve 14 due to the flow guide 16, and is guided deep (the right side of FIG. 8) into the thermal puffer chamber 10 in the interrupting direction.

A stopper 35 is installed on the outer circumferential surface of the hollow rod 6. The stopper 35 is a member that stops the motion of the check valve 14 when the check valve 14 moves in the non-interrupting direction to open the communicating hole 15. Since the flow guide 16 extends toward the radially outer side obliquely to the axial direction, the hot gas 31 flowing into the thermal puffer chamber 10 flows toward the check valve 14 without being inhibited by the stopper 35.

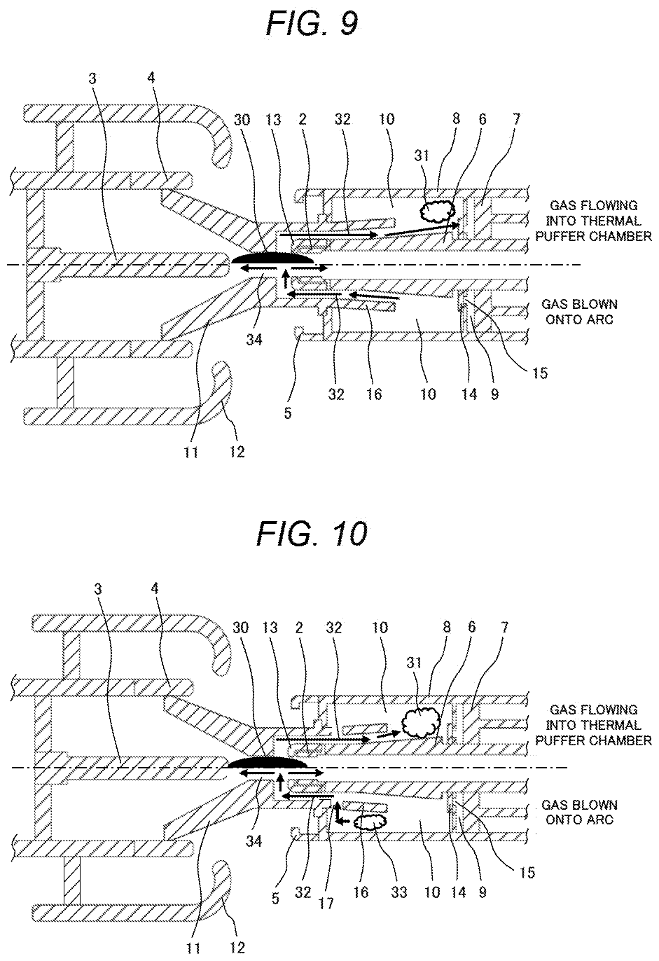

FIG. 9 is a cross-sectional view illustrating the schematic configuration of another gas circuit breaker according to the present embodiment at the time of interruption. The gas circuit breaker illustrated in FIG. 9 includes configurations similar to those of the gas circuit breaker illustrated in FIG. 8, but is different from the gas circuit breaker illustrated in FIG. 8 in terms of the configuration of the hollow rod 6.

In the gas circuit breaker illustrated in FIG. 9, the outer circumferential surface of the hollow rod 6 extends in the axial direction obliquely toward the radially outer side, similar to the flow guide 16. Since the outer circumferential surface of the hollow rod 6 extends toward the radially outer side obliquely to the axial direction, similar to the gas circuit breaker illustrated in FIG. 8, in the gas circuit breaker illustrated in FIG. 9 also, the gas flow path formed with the flow guide 16 and the hollow rod 6 is formed such that the hot gas 31 flowing into the thermal puffer chamber 10 flows toward the check valve 14. Note that although the gas circuit breaker illustrated in FIG. 9 does not include the stopper 35 that stops the motion of the check valve 14, the hollow rod 6 stops the motion of the check valve 14.

At the time of interruption of a large current when a current to be interrupted is relatively large, the pressure inside the thermal puffer chamber 10 is higher than the pressure inside the mechanical puffer chamber 9. Accordingly, the check valve 14 moves in the interrupting direction to close the communicating hole 15, and interrupts communication between the thermal puffer chamber 10 and the mechanical puffer chamber 9. There is a fear that if this operation of the check valve 14 is late, the pressure in the thermal puffer chamber 10 is transferred to the mechanical puffer chamber 9, the puffer reaction force increases due to a pressure drop of the thermal puffer chamber 10 or a pressure increase of the mechanical puffer chamber 9, and the speed of the interrupting operation lowers.

Since the gas flow path formed with flow guide 16 and the hollow rod 6 in the gas circuit breaker according to the present embodiment is formed such that the hot gas 31 flowing into the thermal puffer chamber 10 flows toward the check valve 14, the check valve 14 can move in the interrupting direction faster to close the communicating hole 15 upon receiving the dynamic pressure of the flow of the hot gas 31. In the gas circuit breaker according to the present embodiment, the check valve 14 can be moved faster in the interrupting direction when the hot gas 31 flows into the thermal puffer chamber 10, and a pressure drop of the thermal puffer chamber 10, a pressure increase of the mechanical puffer chamber 9, and lowering of the interruption speed can be prevented.

### Fourth Embodiment

A gas circuit breaker according to a fourth embodiment of the present invention is explained. In the following, configurations of the gas circuit breaker according to the present embodiment that are different from the gas circuit breaker according to the third embodiment are explained mainly.

FIG. 10 is a cross-sectional view illustrating the schematic configuration of the gas circuit breaker according to the present embodiment at the time of interruption. Similar to FIG. 9, in FIG. 10, the upper half illustrates the gas flow 32 that is generated when the gas flows from the arc space 34 (the space where the arc 30 is generated) into the thermal puffer chamber 10, the lower half illustrates the gas flow 32 that is generated when the gas is blown onto the arc 30 from the thermal puffer chamber 10, and an illustration of the gas tank 1 is omitted.

Note that in the gas circuit breaker according to the present embodiment, the outer circumferential surface of the hollow rod 6 may be parallel with the axial direction like the gas circuit breaker illustrated in FIG. 8.

According to the present embodiment, in the gas circuit breaker according to the third embodiment, the flow guide 16 includes holes 17 penetrating therethrough in the radial direction, similar to the gas circuit breaker according to the second embodiment. Since the flow guide 16 include the holes 17, the gas flow similar to the gas flow explained in the second embodiment can be formed at the time of interruption. Accordingly, the gas circuit breaker according to the present embodiment can prevent deterioration of the insulating performance of the gas, and can improve the interruption performance at the time of interruption of an intermediate to small current and at the time of interruption of a large current.

Note that the present invention is not limited to the embodiments described above, but can be modified in various manners. For example, the embodiment described above are explained in detail in order to explain the present invention in an easy-to-understand manner, and the present invention is not necessarily limited to aspects including all the configurations explained. In addition, some of the configurations of an embodiment can be replaced with configurations of other embodiments. In addition, configurations of an embodiment can be added to the configurations of another embodiment. In addition, some of the configurations of each embodiment can be deleted or subjected to addition/replacement of other configurations.

What is claimed is:

1. A gas circuit breaker comprising:
a cylindrical gas tank that is filled with an insulating gas,
a movable main contact that moves in an axial direction to separate from a fixed main contact and interrupt a current;
a movable arc contact that generates an arc between the movable arc contact and a fixed arc contact at a time of the interruption of the current;
a puffer cylinder having one end portion at which the movable main contact is provided;
a hollow rod that is arranged inside the puffer cylinder, has one end portion at which the movable arc contact is provided, and has an inner space through which the insulating gas flows;
a thermal puffer chamber that is formed by being surrounded by the puffer cylinder and the hollow rod;
an insulating cover that is provided at one end portion of the hollow rod, and covers the movable arc contact;
an insulating nozzle provided at one end portion of the puffer cylinder; and
a flow guide that is a cylindrical member extending in the axial direction,
the movable main contact, the movable arc contact, the puffer cylinder, the hollow rod, the thermal puffer chamber, the insulating cover, the insulating nozzle, and the flow guide being included in the cylindrical gas tank, wherein
the flow guide is installed in the thermal puffer chamber, is positioned on an outer circumference side of the hollow rod, and has one end portion connected to the insulating nozzle, and
a space between the flow guide and the hollow rod is connected to a space between the insulating nozzle and the insulating cover, and serves as a flow path of the insulating gas.

2. The gas circuit breaker according to claim 1, wherein
the flow guide has another end portion that is at a position farther from the insulating nozzle in the axial direction than a center of the thermal puffer chamber in the axial direction is.

3. The gas circuit breaker according to claim 1, wherein
a flow path area of a flow path of the insulating gas, the flow path being the space between the flow guide and the hollow rod, is larger than a flow path area of a flow path of the insulating gas, the flow path being the space between the insulating nozzle and the insulating cover.

4. The gas circuit breaker according to claim 1, wherein
the flow guide includes a hole penetrating a side surface of the flow guide in a radial direction.

5. The gas circuit breaker according to claim 4, wherein
a flow path area of the hole is larger than a flow path area of a flow path of the insulating gas, the flow path being the space between the flow guide and the hollow rod.

6. The gas circuit breaker according to claim 4, wherein
a flow path area of the hole is larger than a flow path area of a flow path of the insulating gas, the flow path being the space between the flow guide and the hollow rod, and the flow path area of the flow path of the insulating gas, the flow path being the space between the flow guide and the hollow rod, is larger than a flow path area of a flow path of the insulating gas, the flow path being the space between the insulating nozzle and the insulating cover.

7. The gas circuit breaker according to claim 1, wherein
the flow guide extends in the axial direction obliquely toward a radially outer side.

8. The gas circuit breaker according to claim 7, wherein
the hollow rod has an outer circumferential surface extending in the axial direction obliquely toward the radially outer side.

9. The gas circuit breaker according to claim 7, comprising:
a mechanical puffer chamber connected with the thermal puffer chamber by a communicating hole; and
a check valve that is provided inside the thermal puffer chamber, and opens and closes the communicating hole, wherein
a flow path of the insulating gas, the flow path being the space between the flow guide and the hollow rod, is formed such that the insulating gas flows toward the check valve.

10. The gas circuit breaker according to claim 8, comprising:
a mechanical puffer chamber connected with the thermal puffer chamber by a communicating hole; and
a check valve that is provided inside the thermal puffer chamber, and opens and closes the communicating hole, wherein
a flow path of the insulating gas, the flow path being the space between the flow guide and the hollow rod, is formed such that the insulating gas flows toward the check valve.

11. The gas circuit breaker according to claim 4, wherein
the hole has a flow path area that decreases from a radially outer side toward a radially inner side.
